(19) United States
(12) Patent Application Publication
(10) Pub. No.: US 2011/0240412 A1
(43) Pub. Date: Oct. 6, 2011

(54) ELEVATOR BRAKING CONTROL

(76) Inventors: Greg A. Schienda, Plantsville, CT (US); Harold Terry, Avon, CT (US)

(21) Appl. No.: 13/139,369

(22) PCT Filed: Dec. 17, 2008
(86) PCT No.: PCT/US08/87093

§ 371 Date: Jun. 13, 2011

(51) Int. Cl. B66B 5/04

(52) U.S. Cl. 187/305

(57) ABSTRACT

An exemplary elevator system includes an elevator car. A (22,42) car status indicator (60) provides information indicative of every position of the car and the velocity of the car. A controller (70) controls elevator car movement responsive to an indication from the car status indicator (60) that the elevator car is moving too fast near a landing corresponding to a scheduled stop of the elevator car.

### BACKGROUND

Elevators typically include a car that moves vertically through a hoistway between different levels of a building. Various known control functions ensure a desired quality of elevator service. For example, there are known techniques for controlling the speed with which an elevator car moves according to a prescribed profile that ensures rapid service while maintaining passenger comfort. Elevator motion profiles include acceleration, constant velocity and deceleration rates, for example. Controlling acceleration and deceleration is useful to control how an elevator car departs from a landing at which the elevator car was parked or approaches a landing for a scheduled stop.

Example devices used for elevator speed control include proximity switches positioned near landings. If an elevator approaches the landing in a manner that is inconsistent with the desired motion profile, that trips the corresponding proximity switch, which instigates a controlled stop of the elevator car. Such a controlled stop is usually accomplished by controlling a brake associated with the motor responsible for moving the elevator car. One drawback associated with known systems using such switches is that they require installation and maintenance procedures.

Another speed controlling device is an overspeed governor that is used to detect when an elevator car is moving above a desired speed threshold. The governor is typically used to instigate an emergency stop using safeties that are mounted on the elevator car. Governors tend to be relatively high maintenance devices.

Some arrangements have been proposed that include more than one car within a single hoistway. Placing more than one elevator car in a hoistway presents special considerations regarding controlling the position and movement of the cars to avoid contact between the cars. Such considerations are in addition to the motion control issues presented by systems having a single car in a hoistway.

### SUMMARY OF THE INVENTION

An exemplary elevator system includes an elevator car. A car status indicator provides information indicative of every position of the car and the velocity of the car. A controller controls elevator car movement responsive to an indication from the car status indicator that the elevator car is moving too fast near a landing corresponding to a scheduled stop of the elevator car.

An exemplary method of controlling elevator car movement includes determining an absolute position and a velocity of an elevator car. Brake operation is controlled responsive to an indication that the elevator car is moving too fast near a landing corresponding to a scheduled stop of the elevator car.

One example includes a plurality of elevator cars within a single hoistway and the brake operation for each elevator car is individually controlled based on the position and speed of the corresponding car as it moves near a scheduled stop.

The various features and advantages of the disclosed examples will become apparent to those skilled in the art from the following detailed description of the currently preferred embodiments. The drawings that accompany the detailed description can be briefly described as follows.

### BRIEF DESCRIPTION OF THE DRAWING

FIG. 1 schematically illustrates selected portions of an elevator system incorporating a motion control arrangement designed according to an embodiment of this invention.

### DETAILED DESCRIPTION

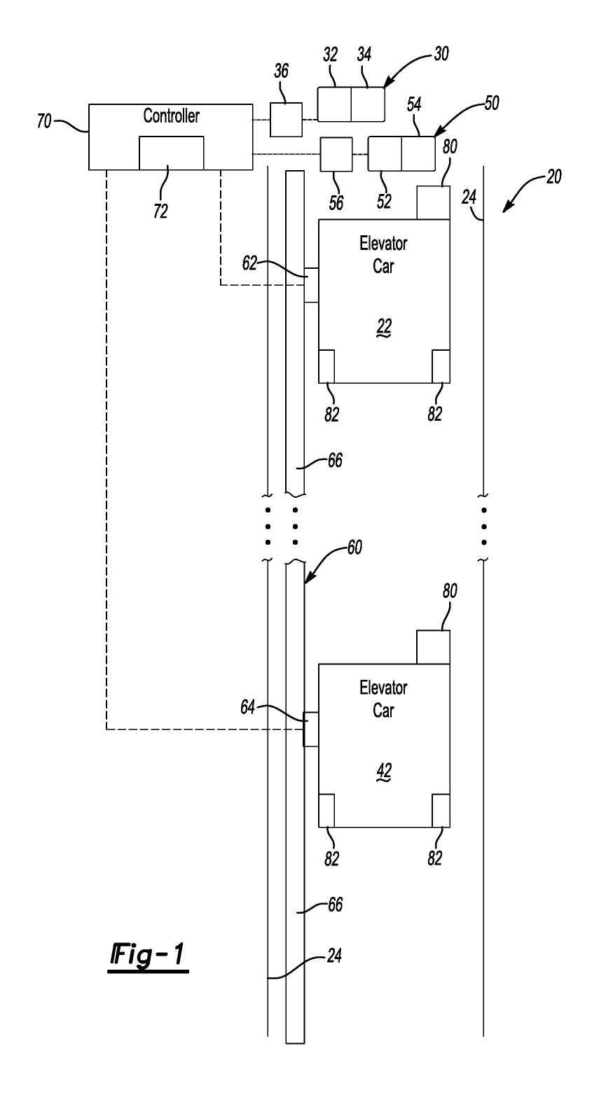

FIG. 1 schematically illustrates selected portions of an elevator system 20 including a first elevator car 22 that is situated for movement within a hoistway 24. The elevator car 22 moves responsive to operation of a machine 30 that includes a motor 32 and a brake 34. A first machine controller 36 controls the operation of the motor 32 and the brake 34 to cause desired movement of the first elevator car 22 or to maintain the car 22 in a desired, stationary location within the hoistway 24.

The illustrated example includes a second elevator car 42 within the hoistway 24. The second elevator car 42 has an associated machine 50 that includes a motor 52 and brake 54. A second machine controller 56 controls the operation of the motor 52 and brake 54 to achieve the desired motion or position of the second elevator car 42.

An elevator car status indicator arrangement 60 provides information that is indicative of every position of each of the elevator cars 22 and 42 and velocity of each of the elevator cars 22 and 42 along the entire travel pathway of the corresponding elevator car in the hoistway 24. In one example, the status indicator arrangement 60 provides absolute position information wherever the cars are in the hoistway 24. The information regarding position is used in one example for determining velocity information based on a relationship between changes in position and time. In another example, separate position and velocity determinations are made.

The example status indicator arrangement 60 includes a position determining device 62 associated with the first elevator car 22 and a second position determining device 64 associated with the second elevator car 42. In this example, the devices 62 and 64 detect (or read) position information from a stationary position indicator 66 within the hoistway 24. One example includes a steel tape having a non-repeating code along the tape such that absolute position information regarding the corresponding car within the hoistway 24 can be determined based on the code detected (or read) by the position determining devices 62 and 64, respectively. Other position indicating devices and corresponding sensors may be used in place of the tape and code detectors (or readers) of the illustrated example.

One example arrangement consistent with FIG. 1 is designed according to the teachings of the published patent application WO 2007/145613, the entirety of which is incorporated into this description by reference. Such an arrangement has the capability to control spacing between the elevator cars according to the teachings of that document and to control elevator car speeds near scheduled stops in accordance with this description.

A controller 70 communicates with the position determining devices 62 and 64 and keeps track of the position of each elevator car, respectively. In one example, a velocity determining module 72 uses position information relative to time to make velocity determinations. In another example, the velocity determining module 72 make independent velocity determinations without requiring position information as gathered by the position determining devices 62 and 64.

The controller 70 communicates with the machine controllers 36 and 56 to maintain elevator car motion within desired parameters. In particular, the controller 70 determines whether either of the elevator cars is moving faster than is desired whenever either of the elevator cars 24 or 42 is moving in relatively close proximity to a scheduled stop for the corresponding car. In one example, the controller 70 is programmed to monitor elevator car speed as the elevator cars approach a scheduled stop. In another example, the controller 70 monitors elevator car speed as the elevator cars approach and depart from a scheduled stop. The scheduled stop may be anywhere along the vertical travel path of the elevator cars 24 and 42 including terminal stops at the ends of the hoistway 24. In one example, the controller 70 monitors elevator car speed as the elevator cars approach every scheduled stop for each car.

Whenever an elevator car is moving faster than expected in the vicinity of a landing of a scheduled stop, the controller 70 communicates with the corresponding machine controller 36 or 56 to instigate a controlled stop of the corresponding elevator car. In one example, the corresponding machine controller 36 or 56 instigates a brake application using the brake 34, 54 of the corresponding machine.

This approach allows for eliminating the need for mechanical proximity switches and associated vanes in the hoistway for detecting the speed of an elevator car that is approaching the position for a scheduled stop.

Another feature of one example is that the controller 70 is programmed to determine whenever either of the elevator cars is moving with a velocity that exceeds a threshold corresponding to an overspeed condition. This determination can be made regardless of the position of the elevator car in the hoistway 24 although certain positions such as the ends of the hoistway may have different velocity thresholds. In the event that such a car moves in excess of the threshold, the controller 70 communicates with the corresponding machine controller, which responds by applying the corresponding brake 34, 54 to stop the corresponding elevator car from moving.

One example includes a safety activator 80 associated with each car to activate safeties 82 that are useful for an emergency stop in situations where a machine brake application is not sufficient to stop an elevator car as desired. The safeties 82 operate in a known manner to cause the associated elevator car to stop. In one example, the safeties 82 engage a guide rail (not shown) in a known manner responsive to a command or actuation that instigates a safety stop. Operating safeties responsive to a determination by the controller 70 allows for eliminating a separate governor device from the elevator system 20. In this example, the controller 70 communicates with the safety activators 80 as needed to trigger a braking operation involving the safeties 82.

The illustrated example allows for eliminating mechanical or electronic components previously provided in elevator systems such as proximity switches and overspeed governors. Without a requirement for such devices, elevator system installation and maintenance economies are improved by the reduced materials and labor costs.

The functions performed by the controller 70 for position determination, velocity monitoring and communicating braking activation information may be realized with a variety of configurations of hardware, software, firmware or a combination of these. In some examples, the controller 70 is a dedicated device or software module. In other examples, the controller 70 is incorporated into one or more other controllers such as the machine controller 36, 56, a group controller (not illustrated) or a dispatch controller (not illustrated). Those skilled in the art who have the benefit of this description will be able to realize a controller that performs consistent with the described functions of the example controller 70 to meet the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-14. (canceled)

15. An elevator system, comprising:
an elevator car;
a car status indicator that provides information that is indicative of every position of the elevator car and a velocity of the elevator car;
a controller that controls movement of the elevator car responsive to the information indicating that the elevator car is moving too fast near a landing corresponding to a scheduled stop of the elevator car; and
a machine having a motor and brake for controlling movement of the elevator car and wherein the controller controls operation of the brake to stop the elevator car responsive to the information indicating that the car is moving too fast near the landing.

16. The elevator system of claim 15, wherein the controller instigates a stop of the elevator car responsive to the information indicating that the elevator car is moving too fast near the landing.

17. The elevator system of claim 15, comprising safeties associated with the elevator car for selectively causing the elevator car to stop and wherein the controller controls operation of the safeties to cause the elevator car to stop responsive to the information indicating that the elevator car is moving at a speed that exceeds an overspeed threshold.

18. The elevator system of claim 15, wherein the controller uses the information regarding the position of the elevator car relative to time to determine the velocity of the elevator car.

19. The elevator system of claim 15, comprising
a second elevator car that is moveable along the same vertical path as the elevator car; and
wherein the car status indicator provides information indicative of every position of each of the elevator cars, respectively, and the controller controls movement of each of the elevator cars, respectively, responsive to the information.

20. The elevator system of claim 15, wherein the car status indicator provides absolute position information regarding every position of the elevator car.

21. A method of controlling movement of an elevator car, comprising the steps of:
providing information regarding every position of the elevator car and a velocity of the elevator car;
determining if the elevator car is moving too fast near a landing corresponding to a scheduled stop of the elevator car;
controlling movement of the elevator car responsive to the determining; and
controlling operation of a brake associated with a machine for moving the elevator car to stop the elevator car responsive to the information indicating that the car is moving too fast near the landing.

22. The method of claim 21, comprising
instigating a stop of the elevator car responsive to the information indicating that the elevator car is moving too fast near the landing.

23. The method of claim 21, comprising
activating safeties associated with the elevator car to cause the elevator car to stop responsive to the information indicating that the elevator car is moving at a speed that exceeds an overspeed threshold.

24. The method of claim 21, comprising
determining the velocity of the elevator car from the information regarding the position of the elevator car relative to time.

25. The method of claim 21, wherein there is more than one elevator car within a single hoistway and the method comprises
providing information indicative of every position of each of the elevator cars, respectively; and
controlling movement of each of the elevator cars, respectively, responsive to the information.

26. The method of claim 21, comprising
providing absolute position information regarding every position of the elevator car.
